(19) United States
(12) Patent Application Publication
(10) Pub. No.: US 2015/0217243 A1
(43) Pub. Date: Aug. 6, 2015

(54) VERTICAL-TYPE CONTINUOUS HIGH-SPEED STIRRING DEVICE

(71) Applicant: VALUE SUPPLIER & DEBELOPER CORPORATION, Chiba (JP)

(72) Inventor: Keiji Kurosawa, Chiba-ken (JP)

(73) Assignee: VALUE SUPPLIER & DEVELOPER CORPORATION, Chiba (JP)

(21) Appl. No.: 14/129,424

(22) PCT Filed: Sep. 27, 2013
(86) PCT No.: PCT/JP13/05761

§ 371 Date: Dec. 26, 2013

(30) Foreign Application Priority Data
Mar. 28, 2013 (JP) 2013-069682

(51) Int. Cl. B01F 7/24; B01F 15/02; B01F 7/18; B01F 7/00; B01F 7/16

(52) U.S. Cl. CPC B01F 7/247; B01F 7/007; B01F 7/00708; B01F 7/169; B01F 7/18; B01F 15/0276

(57) ABSTRACT

A stirring device is provided including a liquid supply pipe disposed on a central axis of a cylindrical container and discharges liquid into the cylindrical container; a rotation hollow shaft disposed coaxially outside the liquid supply pipe; a rotor which is coaxially fixed to the rotation hollow shaft including a plurality of rotor blades; a screw conveyor plate wound around the rotor in a spiral pattern; an inner-side cylindrical container provided in the cylindrical container around the rotor; a division plate which defines an upper and a lower portion inside the cylindrical container having a plurality of through-holes; an inclined bottom plate disposed between the cylindrical container below the division plate and the inner-side cylindrical container; a processed fluid outlet provided on a side wall of the cylindrical container; and a motor to rotate the rotation hollow shaft.

### RELATED APPLICATIONS

This application claims priority to Japanese Application No. 2013-069682, filed Mar. 28, 2013, and to PCT/JP2013/005761, filed Sep. 27, 2013, which also claims priority to Japanese Application No. 2013-069682, each of whose contents are expressly incorporated by reference herein.

### TECHNICAL FIELD

One or more aspects of the present invention relate to a device that stirs a liquid that is mixed with at least one type of liquid or powder mixed liquid, and particularly to a vertical-type continuous high-speed stirring device that is equipped with a rotor blade that is rotated at high speed by a vertical rotation shaft.

### BACKGROUND ART

What is known is emulsion fuel that is made by adding water to fuel oil such as light oil, heavy oil, or heavy gravity oil and stirring, and dispersing the water in the fuel oil. The heavy gravity oil is an oil that is poor in liquidity at normal temperature and becomes liquid only when heated to high temperatures; the heavy gravity oils preferably include the following oil liquids, which contain 90% by weight or more of a component with a boiling point of 340 degrees Celsius or more at normal pressure: petroleum-based asphalts and mixtures of the oils, various processed products of petroleum-based asphalts, intermediate products thereof, residues and mixtures of the residues, high pour-point oil or crude oil that does not flow at normal temperature, petroleum-based tar pitch and mixtures of the oils, bitumens, natural asphalt, Orinoco tar, tar, residue oil, and the like.

When the emulsion fuel is sprayed to a high temperature place, the water in the fuel droplets immediately comes to the boil; the fuel droplets are atomized (Micro-explosion), thereby realizing high-speed, highly-efficient combustion and suppressing generation of CO and soot. Moreover, the evaporation of water helps lower flame temperature; because the fuel has an effect of reducing NOx in exhaust gas, which is known as low-pollution fuel.

When the emulsion fuel is produced, the performance of a mixing device (mixer) significantly affects the combustion performance and long-term stability of the emulsion fuel produced. As a conventional mixing device, an emulsion production device that is disclosed in Japanese Patent Application Laid-open Publication No. 2008-185223 (Patent Document 1), which is a previous application by the applicant, is known.

The emulsion production device is a device that continuously atomizes a mixed liquid by using a rotor blade that a rotor, which rotates at high speed or 10,000 rpm per minute or more, includes. The emulsion produced by the device is very fine with an average particle diameter of 0.1 μm. What is obtained is emulsion that is stable over time.

### BRIEF SUMMARY

In the case of the above-described conventional emulsion production device, however, an amount of emulsion generated per minute is not necessarily sufficient, and it is hoped that an improvement thereof will be made. Therefore, an aspect of one or more embodiments of the present invention is to improve a vertical-type continuous high-speed stirring device that is used in producing emulsion, for example, and particularly to provide a vertical-type continuous high-speed stirring device that can save power consumption by making the device smaller in size, and can increase an amount of a processed fluid generated per minute, which is obtained by stirring.

A vertical-type continuous high-speed stirring device according to one or more embodiments of the present invention includes: a cylindrical container which includes a cover plate and a bottom plate; a liquid supply pipe which is disposed substantially on a central axis of the cylindrical container, which is supplied with at least one type of liquid from an upper end portion, and which passes through the cover plate of the cylindrical container and discharges the liquid above the bottom portion; a rotation hollow shaft which is disposed coaxially outside the liquid supply pipe and which rotates at high speed; an upper rotating body which is coaxially fixed to the rotation hollow shaft; a conical lower rotating body which is disposed below the upper rotating body, and which forms a flow path that leads the liquid flowing out of a lower end portion of the liquid supply pipe to an inner-wall direction of the cylindrical container, and which forms a first chamber between a lower surface of the upper rotating body and an upper surface of the lower rotating body; a rotor whose upper and lower ends are respectively fixed to the upper rotating body and the lower rotating body, and which includes a plurality of blades that are radially provided around the rotation hollow shaft; a screw conveyor which is a strip-shaped plate that is wound and fixed around the rotor in a spiral pattern; an inner-side cylindrical container which is provided in the cylindrical container and around the rotor containing the screw conveyor, and whose lower end is fixed onto the bottom plate of the cylindrical container, and whose upper end is open; a division plate which defines an upper and a lower portion inside the cylindrical container at an upper end portion of the inner-side cylindrical container to form a second chamber between a lower surface of the cover plate of the cylindrical container and the division plate and in which a plurality of through-holes are formed; an inclined bottom plate which is so disposed as to be inclined with respect to the bottom plate of the cylindrical container in such a way as to form a third chamber between a portion of the cylindrical container below the division plate and the inner-side cylindrical container; a processed fluid outlet which is provided on a side wall of the cylindrical container in such a way as to discharge a processed fluid stored in the third chamber out of the cylindrical container at a low position of the inclined bottom plate; and driving means for rotating and driving the rotation hollow shaft.

The vertical-type continuous high-speed stirring device according to one or more embodiments of the present invention is characterized in that the rotation hollow shaft rotates at least at 10,000 rpm or more.

The vertical-type continuous high-speed stirring device according to one or more embodiments of the present invention is characterized in that start ends and termination ends of two strip-shaped screw plates that are wound in a spiral pattern are disposed at opposite positions in a diametrical direction on a peripheral circumference of the first rotor.

The vertical-type continuous high-speed stirring device according to one or more embodiments of the present invention is characterized in that the strip-shaped screw plate includes two strip-shaped screw plates that are alternately wound in a spiral pattern.

The vertical-type continuous high-speed stirring device according to one or more embodiments of the present invention is characterized in that to the liquid supply pipe, at least two types of liquid are mixed and supplied, and the liquids are discharged above the upper surface of the lower rotation body after passing through the cover plate of the cylindrical container.

The vertical-type continuous high-speed stirring device according to one or more embodiments of the present invention is characterized in that to the liquid supply pipe, at least the one type of liquid is mixed with powder before being supplied.

Furthermore, the vertical-type continuous high-speed stirring device according to one or more embodiments of the present invention is characterized in that the upper rotating body that constitutes the rotor includes a conical lower surface, upper and lower surfaces of the first chamber are defined by the conical lower surface of the upper rotating body and the conical upper surface of the lower rotating body, and the first chamber is formed as a space that is open to the inner-side cylindrical container on an outer peripheral surface of the rotor.

Furthermore, the vertical-type continuous high-speed stirring device according to one or more embodiments of the present invention is characterized in that a plurality of blades that constitute the rotor are paddles that are radially provided in an opening portion inside the first chamber.

Furthermore, according to the vertical-type continuous high-speed stirring device of one or more embodiments of the present invention is characterized in that a plurality of paddles that constitute the rotor are fixed between the upper rotating body and the lower rotating body in such a way that an outer peripheral end portion of each paddle forms, along with outer peripheral surfaces of the upper rotating body and lower rotating body of the rotor, a cylindrical outer peripheral surface.

Furthermore, the vertical-type continuous high-speed stirring device according to one or more embodiments of the present invention is characterized in that the second chamber communicates with the inner-side cylindrical container at an upper end portion thereof, and the second chamber communicates with the third chamber through a plurality of through-holes formed in the division plate.

Furthermore, the vertical-type continuous high-speed stirring device according to one or more embodiments of the present invention is characterized in that the third chamber is formed by dividing, in a vertical direction, a space between an inner wall of the cylindrical container and an outer wall of the inner-side cylindrical container with an inclined bottom plate that traverses in a direction that obliquely intersects with respect to the rotation hollow shaft.

Furthermore, the vertical-type continuous high-speed stirring device according to one or more embodiments of the present invention is characterized in that the division plate is an annular plate, and a plurality of through-holes are long holes that are formed along a circumference of the annular plate.

Furthermore, the vertical-type continuous high-speed stirring device according to one or more embodiments of the present invention is characterized in that the processed fluid outlet is provided on a side wall of the cylindrical container and at the lowest position of the inclined bottom plate of the third chamber to allow a processed fluid stored in the third chamber to be discharged out of the cylindrical container due to gravity thereof.

According to one or more embodiments of the present invention, it is possible to provide a vertical-type continuous high-speed stirring device production capacity of which is significantly improved.

### BRIEF DESCRIPTION OF THE DRAWINGS

FIG. 1 is a vertical cross-sectional view showing an embodiment of a vertical-type continuous high-speed stirring device according to one or more embodiments of the present invention.

FIG. 2 is a plane view showing the arrangement of paddles and screw conveyers in a rotor that constitutes a vertical-type continuous high-speed stirring device according to one or more embodiments of the present invention.

FIG. 3 is a perspective view showing the configuration of a rotor that constitutes a vertical-type continuous high-speed stirring device according to one or more embodiments of the present invention.

FIG. 4 is a plane view showing the arrangement of long holes in a division plate that constitutes a vertical-type continuous high-speed stirring device according to one or more embodiments of the present invention.

### DESCRIPTION OF EMBODIMENTS

Hereinafter, an embodiment of a vertical-type continuous high-speed stirring device according to the present invention will be described with reference to the accompanying drawings.

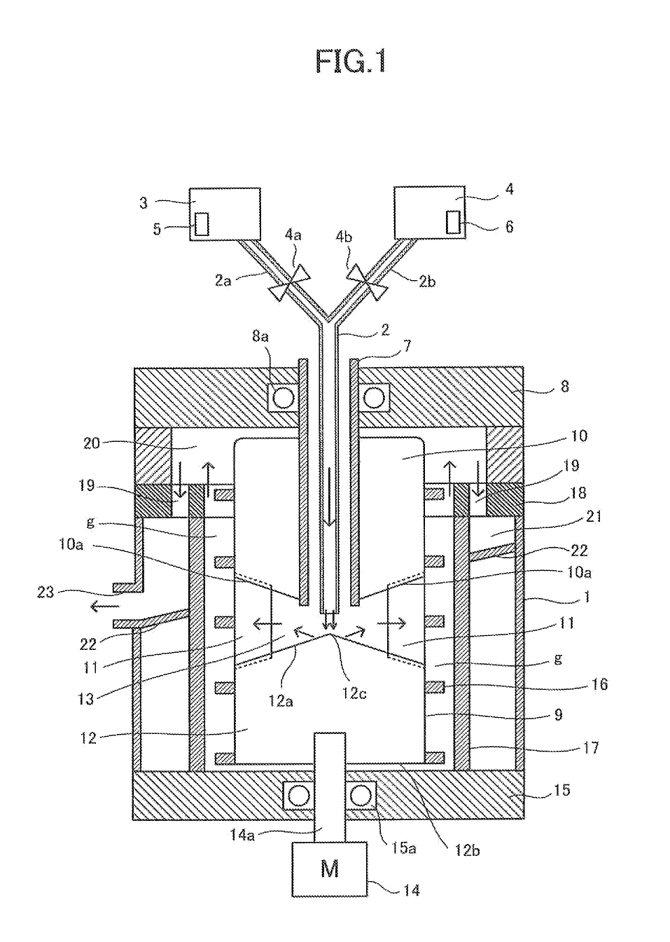

FIG. 1 is a cross-sectional view showing an embodiment of the vertical-type continuous high-speed stirring device according to an embodiment of the present invention.

As shown in FIG. 1, as for the basic configuration of the high-speed stirring device, a liquid supply pipe 2 is provided in a vertical direction along a central axis of a cylindrical container 1 to mix and transport oil (light oil, kerosene, Bunker A, or the like) and water. The liquid supply pipe 2 includes branch pipes 2a and 2b, which diverge from an upper portion thereof in a way that makes a Y-shape. To the branch pipes 2a and 2b, an oil tank 3 and a water tank 4 are respectively connected. Specifically, the liquid supply pipe 2 is made of stainless steel, with the Y-shaped, two-pronged upper portion having the branch pipes 2a and 2b on which flow valves 4a and 4b are respectively provided. Through the flow valves 4a and 4b, the tip of the branch pipe 2a is disposed at a bottom portion of the oil tank 3, and the tip of the branch pipe 2b at a bottom portion of the water tank 4. Incidentally, both the oil tank 3 and the water tank 4 are made of stainless steel; there are built-in heaters 5 and 6 inside the oil tank 3 and the water tank 4, respectively, which are used to keep liquid (water or oil) stored therein at a predetermined temperature (e.g. 55 degrees Celsius).

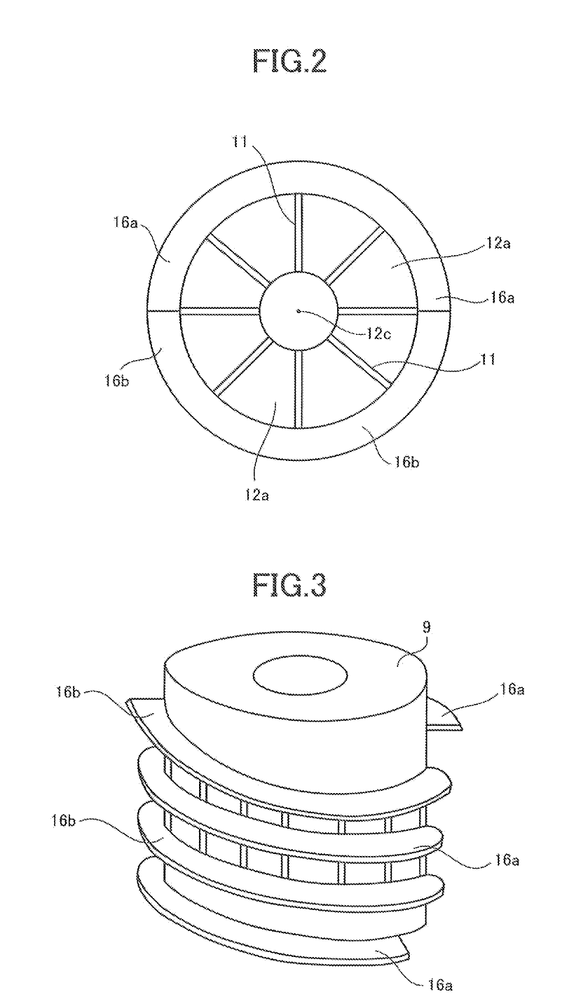

A rotation hollow shaft 7, which rotates at high speed away from the liquid supply pipe 2, is placed outside the liquid supply pipe 2, coaxially with the liquid supply pipe 2. An upper end portion of the rotation hollow shaft 7 is supported by a cover plate 8 of the cylindrical container 1 through a first bearing 8a in a rotatable manner and a lower end portion thereof is inserted into the cylindrical container 1. A circular truncated cone-shaped upper rotating body 10 of a rotor 9 is concentrically fixed to a portion of the rotation hollow shaft 7 that has been inserted into the cylindrical container 1. As shown in FIG. 2 which is a plane view, eight plate-like rotor blades (referred to as “paddles,” hereinafter) 11 are radially fixed on a peripheral portion of a lower surface 10a of the upper rotating body 10 of the rotor 9. A lower rotating body 12, which includes a conical bottom plate that is formed integrally with the rotor 9, is provided at a lower portion of the rotor 9. The lower rotating body 12 has a conical upper surface 12a and a flat bottom surface 12b. An apex 12c of the conical upper surface 12a is so disposed as to face a lower end portion of the liquid supply pipe 2 and the apex 12c is formed in such a way that the apex angle thereof is equal to about 60 degrees. A first chamber 13 is formed between the lower surface 10a of the upper rotating body 10 and the conical upper surface 12a of the lower rotating body 12 of the rotor 9. A peripheral portion of the chamber 13 is radially divided by the eight paddles 11. Upper sides of the paddles 11 are implanted in the lower surface 10a of the upper rotating body 10, and lower sides of the paddles 11 are implanted in the inclined upper surface 12a of the lower rotating body 12. The paddles 11 are fixed between the upper rotating body 10 and the lower rotating body 12 in such a way as that an outer peripheral end portion of each paddle 11 forms, along with outer peripheral surfaces of the upper rotating body 10 and lower rotating body 12 of the rotor 9, a cylindrical outer peripheral surface. The rotor 9 includes the upper rotating body 10, the paddles 11, and the lower rotating body 12, and is made of stainless steel, for example.

Around the rotor 9 having the above configuration, strip-shaped screw conveyers 16, which are plates, are so provided as to be wound in a spiral pattern. As shown in FIG. 3 which is a perspective view, the screw conveyers 16 include a pair of screw conveyers 16a and 16b, which have substantially the same shape and are strip-shaped plates made of stainless steel. The screw conveyers 16a and 16b are wound around the rotor 9 in such a way that a screw conveyers 16a is located between screw conveyers 16b, or that a screw conveyers 16b is located between screw conveyers 16a. Specifically, as shown in FIG. 3, the pair of screw conveyers 16a and 16b starts to be wound, in an upper end portion of the rotor 9, at an opposite-side position of a diametrical direction on the circumference of the rotor 9. Although not shown in the diagram, in a lower end portion of the rotor 9, the winding is terminated at an opposite-side position of a diametrical direction on the circumference of the rotor 9. The pair of screw conveyers 16a and 16b is so disposed as to be adjacent to each other at an intermediate position between the start end of the winding and the termination end.

An inner-side cylindrical container 17 is provided inside the cylindrical container 1 around the rotor 9 having the above configuration. A gap g is formed as a flow path between a peripheral portion of the rotor 9 and a side wall of the inner-side cylindrical container 17.

As shown in FIG. 1, the lower rotating body 12 of the rotor 9 is connected directly to a rotation shaft 14a of a motor 14, which is provided in a lower portion of the cylindrical container 11. The rotation shaft 14a of the motor 14 is supported in a rotatable manner on a bottom plate 15 of the cylindrical container 1 through a second bearing 15a. The rotor 9 is rotated at high speed, e.g. at 10,000 rpm or more, or preferably at 15,000 rpm by the motor 14. A centrifugal force of 8,000 G or more is generated by rotation of the rotor 9 or paddles 11. That is, the rotation shaft of the motor 14 is connected directly to the lower rotating body 12 of the rotor 9 and the lower rotating body 12 of the rotor 9 is integrated with the upper rotating body 10 through the eight paddles 11. Therefore, the rotor 9 is rotated at high speed by the motor 14. On the other hand, the rotation hollow shaft 7 is fixed coaxially at a central portion of the upper rotating body 10. Therefore, the rotation hollow shaft 7 rotates together with the rotor 9 at high speed or at 15,000 rpm.

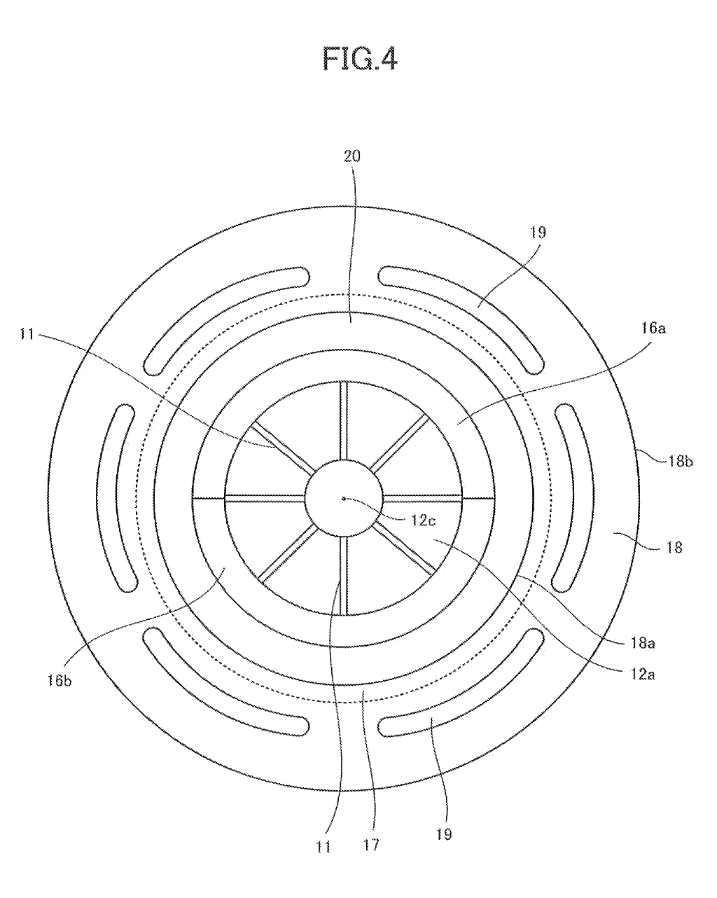

A division plate 18 is provided inside the cylindrical container 1 at an upper end portion of the inner-side cylindrical container 17. As shown in FIG. 4, the division plate 18 is a ring-shaped plate as a whole. An inner-side edge portion 18a thereof is joined to an upper end portion of the inner-side cylindrical container 17, and an outer-side edge portion 18b is joined to an inner wall of the cylindrical container 1. Six long holes (orifices) 19 are provided at regular intervals on the division plate 18, as shown in FIG. 4, which is a top view thereof, along a circumferential direction. As described later, the long holes 19 form flow paths that lead the fluid, which flows upward inside the gap g formed between the periphery of the rotor 9 and the side wall of the inner-side cylindrical container 17, to a lower side again. Incidentally, at a central portion of the ring-shaped division plate 18, the rotor 9 shown in FIG. 2 is disposed.

A second chamber 20 is formed in the cylindrical container 1 above the division plate 18. The second chamber 20 is formed in a space between the cover plate 8 of the cylindrical container 1 and the division plate 18. The second chamber 20 communicates with the inner-side cylindrical container 17, which is provided around the rotor 9 at an upper-end opening portion. As described later, the emulsion that is conveyed upward by the screw conveyers 16 provided around the rotor 9 flows in the second chamber 20 as indicated by upward arrows in the diagram. The emulsion liquid that has been conveyed into the second chamber 20 then flows into a third chamber 21 as indicated by downward arrows via the long holes 19 formed in the division plate 18. That is, the second chamber 20 communicates with the inner-side cylindrical container 17 at an upper end portion thereof Moreover, the second chamber 20 communicates with the third chamber via the long holes 19, which are a plurality of through-holes formed in the division plate 18.

As shown in FIG. 1, the third chamber 21 is formed by providing a hollow cylindrical space formed on an outer side of the inner-side cylindrical container 17 and on an inner side of the cylindrical container 1 with an inclined bottom plate 22 which traverses the cylindrical container 1 diagonally to the bottom plate 15 thereof. That is, the third chamber 21 is a space that is defined by the inclined bottom plate 22 and the division plate 18 in the vertical direction, and is defined by an outer periphery of the inner-side cylindrical container 17 and an inner periphery of the cylindrical container 1 in the horizontal direction. The third chamber 21 is provided with a fluid outlet 23. The outlet 23 is constituted by an opening, which is formed on a side wall of the cylindrical container 1 at a position where the height of the inclined bottom plate 22 of the third chamber 21 is low, or preferably where the height thereof is lowest.

The following describes operation of the vertical-type continuous high-speed stirring device having the above configuration. In the following description, an operation of producing emulsion fuel by mixing oil and water will be described. The present invention is, however, not limited to such a use only. Needless to say, the present invention is also available for a process of producing various kinds of emulsion other than fuel, or a process of mixing heavy oil and activated clay or activated sludge to carry out desulfurization or produce a new fuel by mixing the mixtures.

The liquids (e.g. heavy oil and water) stored in the oil tank 3 and the water tank 4 are each kept at around 55 degrees Celsius by the heater 5 and 6. The liquids in the tanks 3 and 4 pass through the branch pipes 2a and 2b and then the flow regulation valves 4a and 4b, and flow into the liquid supply pipe 2, in which a mixed liquid is obtained as the water and the oil are mixed, and the mixed liquid freely falls inside the liquid supply pipe 2. Incidentally, all the arrows in FIG. 1 represent the directions of flows of liquid or fluid.

Incidentally, the liquids flowing into the liquid supply pipe 2 are regulated by the flow regulation valves 4a and 4b, respectively. The ratio of the mixed liquid freely falling inside the liquid supply pipe 2 is, by volume ratio: Water:Oil=40:60.

The mixed liquid that has freely fallen inside the liquid supply pipe 2 flows into the first chamber 13. The mixed liquid is sprayed in the circumferential direction as the mixed liquid hits the upper surface 12a of the lower rotating body 12, and then flows into a flow path that is divided by a plurality of paddles 11. Since the paddles 11 are rotating at high speed, the mixed liquid is sheared and crushed by the paddles 11. As a result, the mixed liquid is transformed into an emulsion fuel consisting of fine particles with a particle diameter of about φ5 μm, for example.

Furthermore, the transformed emulsion fuel hits the side wall of the inner-side cylindrical container 17 due to a centrifugal force of the rotor 9, and is pushed into the gap g formed between the inner-side cylindrical container 17 and the periphery of the rotor 9. The emulsion fuel that has been pushed into the gap g is conveyed upward inside the gap g by the screw conveyers 16, which are provided around the rotor 9. The emulsion fuel is conveyed into the second chamber 20, which is formed in an upper portion of the cylindrical container 1.

The emulsion fuel that has been conveyed into the second chamber 20 fills the second chamber 20. Then, the emulsion fuel flows into the third chamber 21, as indicated by downward arrows, via the long holes 19 formed in the division plate 18. The emulsion fuel that has flowed into the third chamber 21 flows downward along the inclined bottom plate 21a due to the gravity of liquid. The emulsion fuel is discharged out of the cylindrical container 1 through the outlet 22, which is preferably formed at the lowest position.

The emulsion production device according to the embodiment of the present invention has made a significant improvement in the production capacity of emulsion produced compared with the above conventional device. That is, while the production capacity of emulsion by the above conventional production device is 1.4 L/min, the production capacity of emulsion by the device of the embodiment of the present invention is 4 L/min, which is about three times greater.

The first reason is that, according to the device according to the embodiment of the present invention, the screw conveyers 16 are provided around the rotor 9, making it possible to strongly push up and convey the emulsion produced in the first chamber 13 into the second chamber 20 by using a rotation force of the rotor 9.

The second reason is that the produced emulsion flows downward, in the third chamber 21, along the inclined bottom plate 21a due to the gravity of liquid, and is discharged out of the cylindrical container 1. Therefore, the rotating and driving of a second paddle, which is required in the conventional device to discharge the liquid, is not required. Thus, all of the driving force of the motor 14 can be dedicated to generating the emulsion fuel, or stirring the fluid at high speed.

The third reason is that, because the second paddle, which is required in the conventional device, is not required, a third bearing that is used to support the rotation hollow shaft 7 in the cylindrical container 1 is not required. Accordingly, an intermediate support body that operates as a division plate in the conventional device is not required. Therefore, flow-path resistance of the fluid passing through a plurality of long holes formed in the intermediate support body is dramatically reduced. As a result, the flow rate of fluid or emulsion flowing in the device is increased, and an amount of emulsion discharged is increased.

In the vertical-type continuous high-speed stirring device according to the embodiment of the present invention, the start point of the spiral winding is 180 degrees away from the end point thereof on the peripheral circumference of the rotor 9 in the screw conveyers 16 provided around the rotor 9. Moreover, the screw conveyers 16 are wound in a spiral pattern in such a way as to be adjacent to each other. Therefore, rotation balance of the rotor 9 is good, having no adverse effect on the high-speed rotation of the rotor 9. Therefore, the stable, high-speed rotation is maintained.

Furthermore, according to the vertical-type continuous high-speed stirring device according to the embodiment of the present invention, the second paddle, which is required in the conventional device to discharge the emulsion liquid out of the cylindrical container 1, is not required as described above. Accordingly, a chamber in which the second paddle is provided is not required, too. Therefore, the advantage is that the device as a whole can be made smaller in size.

Incidentally, the emulsion fuel produced by the vertical-type continuous high-speed stirring device according to the embodiment of the present invention was taken out and the average particle size of the micelles (aggregate) was measured by a particle size distribution measuring device of a laser light scattering type. The result was cp 0.1 μm. Moreover, the emulsion fuel was observed in a static state over one month and separation of the fuel was not recognized at all, proving that the emulsion fuel is very good in stability.

The vertical-type continuous high-speed stirring device according to the present invention is not limited to a process of producing the emulsion fuel. The vertical-type continuous high-speed stirring device is also available for producing other kinds of emulsion, such as edible emulsion.

The vertical-type continuous high-speed stirring device according to the present invention is also able to process water, such as drinking water or plant cultivation water, into ultrafine particles by carrying out a high-speed stirring and shearing process under pressure that is based on a centrifugal force of 8,000 G. In this case, nothing is stored in the oil tank 3 shown in FIG. 1, and water is supplied from the water tank 4.

Furthermore, the vertical-type continuous high-speed stirring device according to one or more embodiments of the present invention is able to produce a fuel oil by, for example, mixing heavy oil with powdered activated earth, and supplying the mixture to a liquid supply pipe to promote chemical reaction of the heavy oil and activated earth. In this case, heavy oil is stored in the oil tank 3 shown in FIG. 1 and activated clay powder is supplied by a screw or the like from a powder tank (not shown) instead of the water tank 4. In this case, heavy oil is discharged in which activated clay that has adsorbed sulfur components of the heavy oil is dispersed from the vertical-type continuous high-speed stirring device. The heavy oil in which the activated clay that has adsorbed the sulfur components is dispersed is stored in a container in a static manner. As a result, the activated clay that has adsorbed the sulfur components of the heavy oil is precipitated and separated from the heavy oil. In this manner, it is possible to purify heavy oil by using so-called desulfurization method.

Furthermore, the vertical-type continuous high-speed stirring device according to one or more embodiments of the present invention is able to produce a new fuel oil by mixing heavy oil with activated sludge, which is an industrial waste at a water treatment plant, and stirring the mixture with the use of the vertical-type continuous high-speed stirring device. According to one or more embodiments of the present invention, it turns the activated sludge into fine particles, which can be mixed well with heavy oil. In this case, heavy oil is stored in the oil tank 3 shown in FIG. 1. Activated sludge is stored in the water tank 4 and is supplied by a screw or the like.

The present invention is not limited to those described above. In an implementation stage, the present invention can be applied in many other fields by modifying the components without departing from the spirit of the invention. Moreover, a plurality of components disclosed in the above embodiment may be appropriately combined to form various inventions. For example, from all the components disclosed in the embodiment, some components may be removed. Furthermore, components in other embodiments may be appropriately combined.

### REFERENCE SIGNS LIST

1: Cylindrical container

2: Liquid supply pipe

3: Oil tank

4: Water tank

5: Heater

6: Heater

7: Rotation hollow shaft

8: Cover plate

8a: First bearing

9: Rotor

10: Upper rotating body

11: Paddle

12: Lower rotating body

13: First chamber

14: Motor

15: Bottom plate

16: Screw conveyer

17: Inner-side cylindrical container

18: Division plate

19: Long hole

20: Second chamber

21: Third chamber

22: Inclined bottom plate

23: Fluid outlet

1. A vertical-type continuous high-speed stirring device, comprising:
a cylindrical container which includes a cover plate and a bottom plate;
a liquid supply pipe which is disposed substantially on a central axis of the cylindrical container, and to which at least one type of liquid is supplied from an upper end portion, and which passes through the cover plate of the cylindrical container and discharges the liquid above the bottom portion;
a rotation hollow shaft which is disposed coaxially outside the liquid supply pipe and which rotates at high speed;
an upper rotating body which is coaxially fixed to the rotation hollow shaft;
a lower rotating body which is disposed below the upper rotating body, and which forms a flow path that leads the liquid flowing out of a lower end portion of the liquid supply pipe to an inner-wall direction of the cylindrical container, and which forms a first chamber between a lower surface of the upper rotating body and an upper surface of the lower rotating body, and which has a conical upper surface;
a rotor whose upper and lower ends are respectively fixed to the upper rotating body and the lower rotating body, and which includes a plurality of blades that are radially provided around the rotation hollow shaft;
a screw conveyor which is a strip-shaped plate that is wound and fixed around the rotor in a spiral pattern;
an inner-side cylindrical container which is provided in the cylindrical container and around the rotor containing the screw conveyor, and whose lower end is fixed onto the bottom plate of the cylindrical container, and whose upper end is open;
a division plate which defines an upper and a lower portion inside the cylindrical container at an upper end portion of the inner-side cylindrical container to form a second chamber between a lower surface of the cover plate of the cylindrical container and the division plate, and in which a plurality of through-holes are formed;
an inclined bottom plate which is so disposed as to be inclined with respect to the bottom plate of the cylindrical container in such a way as to form a third chamber between a portion of the cylindrical container below the division plate and the inner-side cylindrical container;
a processed fluid outlet which is provided on a side wall of the cylindrical container in such a way as to discharge a processed fluid stored in the third chamber out of the cylindrical container at a low position of the inclined bottom plate; and
driving means for rotating and driving the rotation hollow shaft.

2. The vertical-type continuous high-speed stirring device according to claim 1, wherein
the rotation hollow shaft rotates at least at 10,000 rpm or more.

3. The vertical-type continuous high-speed stirring device according to claim 2, wherein
the strip-shaped screw plate includes two strip-shaped screw plates that are alternately wound in a spiral pattern.

4. The vertical-type continuous high-speed stirring device according to claim 3, wherein
start ends and termination ends of the two strip-shaped screw plates that are wound in a spiral pattern are disposed at opposite positions in a diametrical direction on a peripheral circumference of the first rotor.

5. The vertical-type continuous high-speed stirring device according to claim 4, wherein
to the liquid supply pipe, at least two types of liquid are mixed and supplied, and the liquids are discharged above the upper lower rotation body after passing through the cover plate of the cylindrical container.

6. The vertical-type continuous high-speed stirring device according to claim 4, wherein
to the liquid supply pipe, at least the one type of liquid is mixed with powder before being supplied.

7. The vertical-type continuous high-speed stirring device according to claim 1, wherein
the upper rotating body that constitutes the rotor includes a conical lower surface, upper and lower surfaces of the first chamber are defined by the conical lower surface of the upper rotating body and the conical upper surface of the lower rotating body, and the first chamber is formed as a space that is open to the inner-side cylindrical container on an outer peripheral surface of the rotor.

8. The vertical-type continuous high-speed stirring device according to claim 7, wherein
a plurality of blades that constitute the rotor are paddles that are radially provided in an opening portion inside the first chamber.

9. The vertical-type continuous high-speed stirring device according to claim 8, wherein
a plurality of paddles that constitute the rotor are fixed between the upper rotating body and the lower rotating body in such a way that an outer peripheral end portion of each paddle forms, along with outer peripheral surfaces of the upper rotating body and lower rotating body of the rotor, a cylindrical outer peripheral surface.

10. The vertical-type continuous high-speed stirring device according to claim 9, wherein
the second chamber communicates with the inner-side cylindrical container at an upper end portion thereof, and the second chamber communicates with the third chamber through a plurality of through-holes formed in the division plate.

11. The vertical-type continuous high-speed stirring device according to claim 10, wherein
the third chamber is formed by dividing, in a vertical direction, a space between an inner wall of the cylindrical container and an outer wall of the inner-side cylindrical container with an inclined bottom plate that traverses in a direction that obliquely intersects with respect to the rotation hollow shaft.

12. The vertical-type continuous high-speed stirring device according to claim 11, wherein
the division plate is an annular plate, and a plurality of through-holes are long holes that are formed along a circumference of the annular plate.

13. The vertical-type continuous high-speed stirring device according to claim 12, wherein
the processed fluid outlet is provided on a side wall of the cylindrical container and at the lowest position of the inclined bottom plate of the third chamber to allow a processed fluid stored in the third chamber to be discharged out of the cylindrical container due to gravity thereof.
